(19) United States
(12) Patent Application Publication
(10) Pub. No.: US 2019/0013507 A1
(43) Pub. Date: Jan. 10, 2019

(54) STACK-TYPE BATTERY

(71) Applicant: Panasonic Inrellectual Property Management Co., Ltd., Osaka-shi, Osaka (JP)

(72) Inventors: Yoshitaka Shinyashiki, Hyogo (JP); Hitoshi Maeda, Hyogo (JP); Katsutoshi Takeda, Hyogo (JP); Daisuke Ito, Hyogo (JP)

(73) Assignee: Panasonic Intellectual Property Management Co., Ltd., Osaka-shi, Osaka (JP)

(21) Appl. No.: 15/752,419

(22) PCT Filed: Aug. 23, 2016
(86) PCT No.: PCT/JP2016/003815

§ 371 Date: Feb. 13, 2018

(30) Foreign Application Priority Data
Aug. 31, 2015 (JP) 2015-170950

(51) Int. Cl. H01M 2/26; H01M 2/02; H01M 2/30; H01M 2/34; H01M 10/04; H01M 10/0585

(52) U.S. Cl. CPC H01M 2/266; H01M 2/0212; H01M 2/30; H01M 10/0585; H01M 10/0413; H01M 10/0436; H01M 2/34

(57) ABSTRACT

A stack-type battery includes a casing, a stacked electrode assembly housed in the casing, and a terminal to which leads extending from single-plate cells of the stacked electrode assembly are connected. The stacked electrode assembly is divided into first and second electrode assembly blocks in a stacking direction. The terminal includes a first inner terminal portion to which the leads of the first electrode assembly block are connected, a second inner terminal portion to which the leads of the second electrode assembly block are connected, and an outer terminal portion continuous with base ends of the first and second inner terminal portions and extending outside the casing. The terminal has a T-shaped side profile.

### TECHNICAL FIELD

The present disclosure relates to stack-type batteries.

### BACKGROUND ART

A conventionally known stack-type battery includes a stacked electrode assembly composed of a plurality of stacked single-plate cells, each composed of positive and negative electrodes stacked with a separator therebetween. The number of single-plate cells foaming the stacked electrode assembly of such a stack-type battery has been increasing with increasing battery capacity. Accordingly, it has becoming increasingly difficult to connect leads extending from the single-plate cells to a terminal together at one position.

For example, PTL 1 discloses a stack-type battery in which the number of leads connected at one position is limited by dividing leads extending from single-plate cells into groups, stacking the leads of each group on top of each other, and connecting the groups of the leads to a surface of a flat terminal at different positions so as to be shifted from each other.

### CITATION LIST

### Patent Literature

PTL 1: Japanese Published Unexamined Patent Application No. 2008-66170

### SUMMARY OF INVENTION

### Technical Problem

Connecting a plurality of groups of leads to a flat terminal at different positions so as to be shifted from each other, as in the stack-type battery disclosed in PTL 1 above, increases the space required for the connections between the leads and the terminal, which results in an increased battery interior volume loss. This causes a problem in that the overall size of the stack-type battery increases.

For example, for a stack-type battery having a configuration in which a stacked electrode assembly composed of a large number of stacked single-plate cells is housed in a casing composed of cup-shaped casing members bonded together, the positions from which terminals extend are limited to the area around the center of the battery in the thickness direction parallel to the stacking direction of the single-plate cells. Thus, connecting a large number of leads to a surface of a flat terminal in the battery results in an increased battery interior volume loss near the connections in the area around the center.

For a stack-type battery having a structure in which a stacked electrode assembly is housed in a metal case and is sealed in the metal case with a lid equipped with external terminals, terminals extending from the stacked electrode assembly are connected to the external terminals inside the metal case. It is preferred that these connections be made in the area around the center of the battery case (or the stacked electrode assembly) in the thickness direction so that no short circuit occurs through contact with the metal case. Thus, connecting a large number of leads to a surface of a flat terminal in the battery results in an increased battery interior volume loss near the connections in the area around the center.

### Solution to Problem

A stack-type battery according to the present disclosure includes a casing; a stacked electrode assembly housed in the casing and composed of a plurality of stacked single-plate cells, each composed of positive and negative electrodes stacked with a separator therebetween; a positive terminal to which positive leads extending from the positive electrodes of the single-plate cells forming the stacked electrode assembly are connected; and a negative terminal to which negative leads extending from the negative electrodes of the single-plate cells forming the stacked electrode assembly are connected. The stacked electrode assembly is divided into first and second electrode assembly blocks in a stacking direction. At least one of the positive and negative terminals includes a first inner terminal portion to which the leads of the first electrode assembly block are connected, a second inner terminal portion to which the leads of the second electrode assembly block are connected, and an outer terminal portion continuous with base ends of the first and second inner terminal portions and extending outside the casing. The at least one of the positive and negative terminals has a T-shaped side profile famed by the first and second inner terminal portions and the outer terminal portion.

### Advantageous Effects of Invention

The stack-type battery according to the present disclosure allows the battery interior volume loss around the connections between the leads and the terminals to be minimized, which contributes to a reduction in the size and an increase in the energy density of the battery.

### BRIEF DESCRIPTION OF DRAWINGS

FIG. 1 is a perspective view of a stack-type battery according to one embodiment.

FIG. 2 includes sectional views, where FIG. 2(a) is a sectional view taken along line A-A in FIG. 1, and FIG. 2(b) is a sectional view, similar to FIG. 2(a), of a stack-type battery serving as a comparative example.

FIG. 3 is a plan view of a stacked electrode assembly having leads connected to terminals.

FIG. 4 is a perspective view of a terminal.

FIG. 5 illustrates how the leads of the stacked electrode assembly are bonded to the terminal.

FIG. 6 is a perspective view of a cover member.

FIG. 7 includes side views of terminals, where FIG. 7(a) is a side view of the terminals according to this embodiment, and FIGS. 7(b) and 7(c) are side views of terminals according to modifications.

FIG. 8 is a perspective view of a terminal according to a further modification.

FIG. 9 is a perspective view of a stack-type battery according to another embodiment.

### DESCRIPTION OF EMBODIMENTS

An example embodiment will now be described in detail with reference to the accompanying drawings. In this description, the specific details such as shapes, materials, values, and directions are shown by way of example to aid in understanding the invention and may be appropriately changed depending on factors such as application, purpose, and specifications. In addition, if the following includes, for example, a plurality of embodiments or modifications, it is originally contemplated to use any suitable combination of the features thereof.

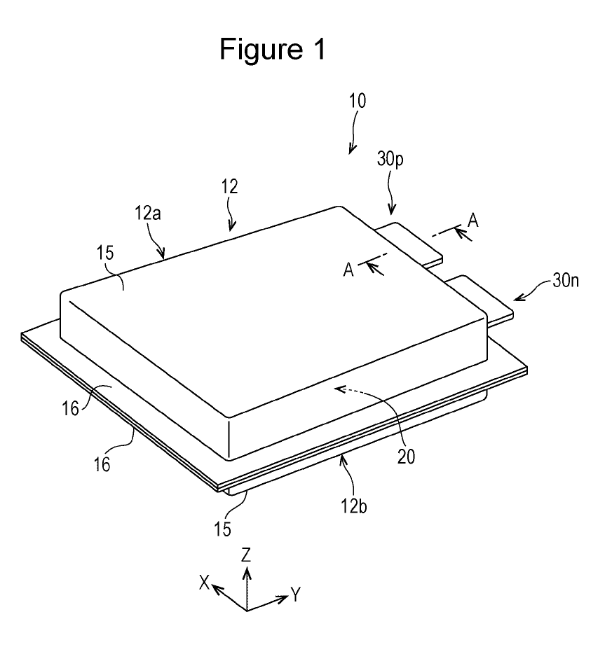

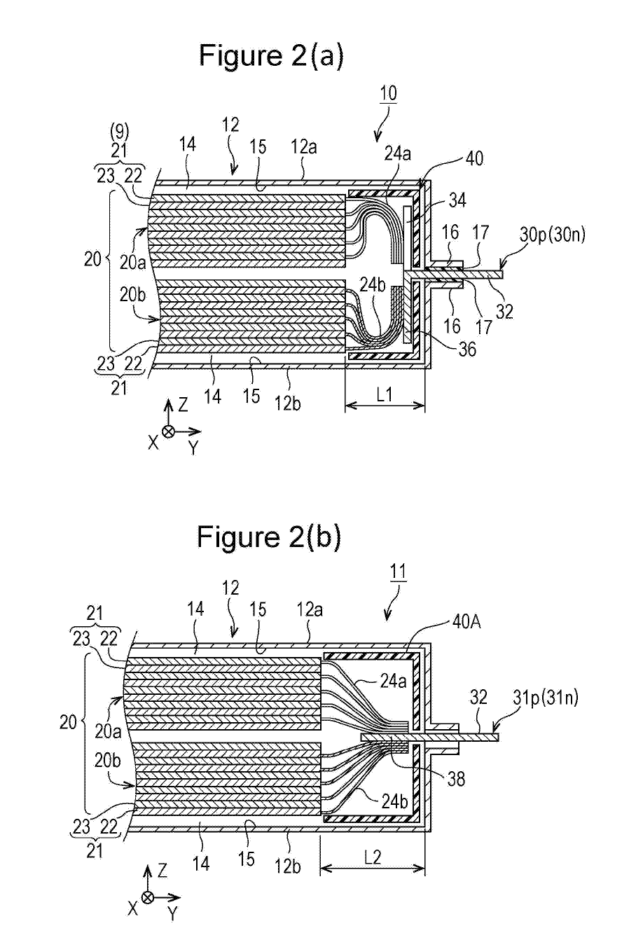

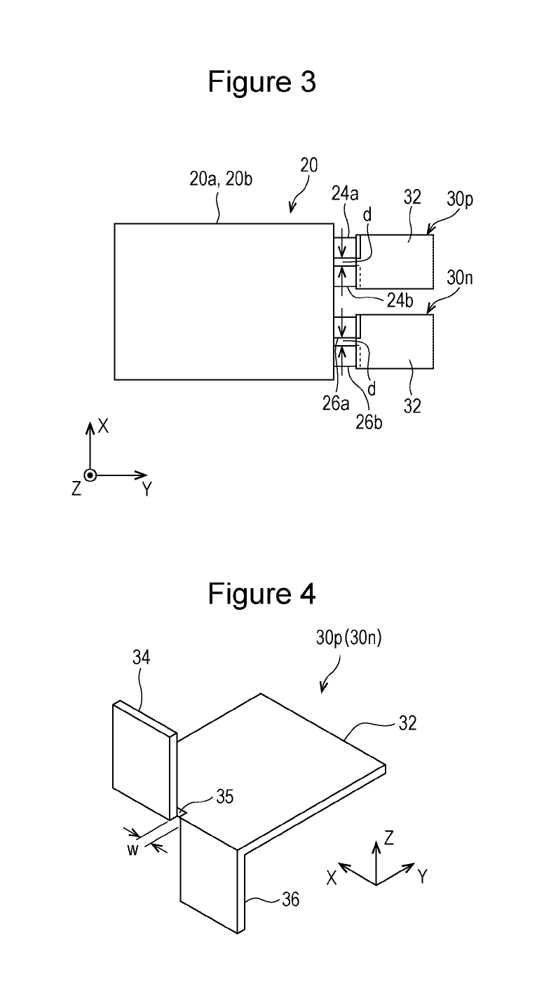

FIG. 1 is a perspective view of a stack-type battery 10 according to one embodiment. FIG. 2(a) is a sectional view taken along line A-A in FIG. 1, and FIG. 2(b) is a sectional view, similar to FIG. 2(a), of a stack-type battery serving as a comparative example. In FIGS. 1, 2(a), and 2(b) (the same applies to FIG. 3 and other figures), the width direction of the stack-type battery is indicated by arrow X, the length direction perpendicular to the width direction is indicated by arrow Y, and the height direction or thickness direction perpendicular to the width and length directions is indicated by arrow Z. Here, the direction indicated by arrow Z coincides with the stacking direction of the single-plate cells foaming the stack-type battery 10.

As shown in FIGS. 1 and 2(a), the stack-type battery 10 includes a casing 12 having the shape of, for example, a flat rectangular prism. The casing 12 is composed of two cup-shaped casing members 12a and 12b. The casing members 12a and 12b are preferably famed of, for example, a laminate film. The laminate film is preferably a film including a metal layer having a resin layer famed on each side thereof. This allows the laminate film to be heat-sealed on the periphery thereof. The metal layer is, for example, a thin film layer of aluminum that functions to prevent the permeation of moisture and other substances.

In this embodiment, the casing members 12a and 12b may be formed so as to have the same shape. Specifically, the casing members 12a and 12b each include, for example, a body 15 famed by drawing and having a housing space 14 having the shape of a flat rectangular prism and a seal portion 16 overhanging from the periphery of the body. The bodies 15 of the casing members 12a and 12b are drawn so as to protrude in opposite directions. The seal portions 16 of the casing members 12a and 12b are bonded together by heat-sealing the resin layers.

The casing of the stack-type battery may also be a closed-bottom metal case having the shape of a rectangular prism. The metal case is sealed with a metal lid by a technique such as laser welding. The metal case and the lid may be formed of materials such as aluminum and alloys thereof and stainless steel.

The stack-type battery 10 has a stacked electrode assembly 20 and a nonaqueous electrolyte housed in the casing 12. The stacked electrode assembly 20 is composed of a plurality of stacked single-plate cells 21. Each single-plate cell 21 is a battery unit composed of a positive electrode 22 and a negative electrode 23 stacked with a separator (not shown) therebetween. To prevent the displacement of the stacked single-plate cells 21 in the width direction X and the length direction Y, it is preferred that tapes be attached to the stacked electrode assembly 20 at a plurality of positions on the four sides so as to extend across both ends of the stacked electrode assembly 20 in the stacking direction Z.

The positive electrode 22 is composed of, for example, a positive electrode current collector and a positive electrode mixture layer famed on the current collector. The positive electrode current collector may be, for example, a foil of a metal that is stable in the potential range of the positive electrode 22, such as aluminum, or a film having a surface layer of such a metal disposed thereon. Preferably, the positive electrode mixture layer contains a positive electrode active material, a conductor, and a binder and is formed on each side of the current collector. The positive electrode 22 can be fabricated, for example, by applying a positive electrode mixture slurry containing components such as a positive electrode active material and a binder to the positive electrode current collector and drying and rolling the coating to form a positive electrode mixture layer on each side of the current collector.

The positive electrode active material may be, for example, a lithium composite oxide. The lithium composite oxide is preferably, but not limited to, a composite oxide represented by the general formula Li₁₊ₓMₐO_{2+b} (where x+a=1, −0.2<x≤0.2, −0.1≤b≤0.1, and M includes at least one of Ni, Co, Mn, and Al). Examples of preferred composite oxides include lithium composite oxides containing Ni, Co, and Mn and lithium composite oxides containing Ni, Co, and Al.

The negative electrode 23 is composed of, for example, a negative electrode current collector and a negative electrode mixture layer famed on the current collector. The negative electrode current collector may be, for example, a foil of a metal that is stable in the potential range of the negative electrode 23, such as copper, or a film having a surface layer of such a metal disposed thereon. Preferably, the negative electrode mixture layer contains a negative electrode active material and a binder. The negative electrode 23 can be fabricated, for example, by applying a negative electrode mixture slurry containing components such as a negative electrode active material and a binder to the negative electrode current collector and drying and rolling the coating to form a negative electrode mixture layer on each side of the current collector.

The negative electrode active material may be any material capable of absorbing and releasing lithium ions, typically graphite. The negative electrode active material may be silicon, a silicon compound, or a mixture thereof. Materials such as silicon compounds may also be used in combination with carbonaceous materials such as graphite. An example of a preferred silicon compound is a silicon oxide represented by SiOₓ (where 0.5≤x≤1.5).

The nonaqueous electrolyte contains a nonaqueous solvent and an electrolyte salt dissolved in the nonaqueous solvent. The nonaqueous electrolyte is not limited to a liquid electrolyte, but may instead be a solid electrolyte such as one containing a gel-like polymer. Examples of nonaqueous solvents that can be used include esters, ethers, nitriles, amides, and mixtures of two or more of these solvents. The nonaqueous solvent may also contain halogen-substituted derivatives of these solvents in which at least some hydrogen atoms are replaced with halogen atoms such as fluorine atoms. The electrolyte salt is preferably a lithium salt.

In this embodiment, the stacked electrode assembly 20 is composed of a first electrode assembly block 20a and a second electrode assembly block 20b. Although FIG. 2(a) shows a gap between the first and second electrode assembly blocks 20a and 20b, there is only a separator for electrical insulation (not shown) therebetween.

FIG. 2(a) shows an example in which the electrode assembly blocks 20a and 20b are each composed of five stacked single-plate cells 21. This, however, should not be construed as limiting; the number of single-plate cells 21 foaming the electrode assembly blocks 20a and 20b is appropriately determined depending on factors such as the capacity of the stack-type battery 10 and the depth of the housing space 14 between the casing members 12a and 12b in the thickness direction Z.

Although the case where the first and second electrode assembly blocks 20a and 20b are composed of the same number of single-plate cells 21 is described in this embodiment, this should not be construed as limiting; the electrode assembly blocks 20a and 20b may be composed of different numbers of single-plate cells 21.

FIG. 3 is a plan view of a stacked electrode assembly having leads connected to terminals. As shown in FIG. 3, the stacked electrode assembly 20 is rectangular as viewed in the direction indicated by arrow Z. That is, the positive and negative electrodes 22 and 23 forming each single-plate cell 21 included in the stacked electrode assembly 20 are rectangular as shown.

As shown in FIG. 2(a), the single-plate cells 21 foaming the stacked electrode assembly 20 have positive leads 24a and 24b extending from the positive electrodes 22. The positive leads 24a and 24b are formed as extensions of the positive electrode current collectors foaming the positive electrodes 22. Although not shown, the single-plate cells 21 forming the stacked electrode assembly 20 also have negative leads 26a and 26b extending from the negative electrodes 23. The negative leads 26a and 26b are famed as extensions of the negative electrode current collectors foaming the negative electrodes 23. The leads 24a, 24b, 26a, and 26b are each formed so as to have, for example, an elongated rectangular shape.

As shown in FIG. 3, the leads 24a, 24b, 26a, and 26b in this embodiment extend in the same direction from an end on one side of the stacked electrode assembly 20 in the length direction. In addition, the positive leads 24a and 24b extend from an end on one side of the stacked electrode assembly 20 in the width direction, whereas the negative leads 26a and 26b extend from an end on the other side of the stacked electrode assembly 20 in the width direction.

The positive leads (hereinafter, where appropriate, referred to as “first positive leads”) 24a extending from the positive electrodes 22 of the single-plate cells 21 included in the first electrode assembly block 20a forming the stacked electrode assembly 20 and the positive leads (hereinafter, where appropriate, referred to as “second positive leads”) 24b extending from the positive electrodes 22 of the single-plate cells 21 included in the second electrode assembly block 20b forming the stacked electrode assembly 20 are arranged so as to be shifted from each other in the width direction. The first and second positive leads 24a and 24b have their ends connected to a positive terminal 30p, for example, by a welding process such as ultrasonic welding.

The negative leads 26a and 26b extending from the single-plate cells 21 foaming the stacked electrode assembly 20 are similarly arranged. Specifically, the negative leads 26a extending from the negative electrodes 23 of the single-plate cells 21 included in the first electrode assembly block 20a forming the stacked electrode assembly 20 and the negative leads 26b extending from the negative electrodes 23 of the single-plate cells 21 included in the second electrode assembly block 20b forming the stacked electrode assembly 20 are arranged so as to be shifted from each other in the width direction of the stacked electrode assembly 20. The first and second negative leads 26a and 26b have their ends connected to a negative terminal 30n, for example, by a welding process such as ultrasonic welding.

The connection configuration between the positive leads 24a and 24b and the positive terminal 30p described above is identical to the connection configuration between the negative leads 26a and 26b and the negative terminal 30n. Accordingly, the connection configuration between the positive leads 24a and 24b and the positive terminal 30p will hereinafter be described by way of example. The positive leads 24a and 24b and the negative leads 26a and 26b may simply be referred to as the leads 24 and 26 when no distinction is made therebetween. The positive terminal 30p and the negative terminal 30n may simply be referred to as the terminals 30 when no distinction is made therebetween.

FIG. 4 is a perspective view of the positive terminal 30p. The positive terminal 30p includes an outer terminal portion 32, a first inner terminal portion 34, and a second inner terminal portion 36. The positive terminal 30p is famed by making a cut 35 into a single rectangular flat metal plate and bending the portions on both sides of the cut 35 at about 90° in opposite directions. As used herein, the term “about 90°” is meant to encompass exactly 90° and angles that can be considered substantially (practically) perpendicular (e.g., 80° to 100°). The thus-famed positive terminal 30p has a T-shaped side profile as viewed in the width direction X, with one end of the outer terminal portion 32 being continuous with the base ends of the first and second inner terminal portions 34 and 36.

The width w of the cut 35 in the positive terminal 30p is preferably set to be equal to the distance d, as shown in FIG. 3, between the first positive leads 24a and the second positive leads 24b of the stacked electrode assembly 20. This prevents the positive leads 24a and 24b from being twisted when, as described later, the first and second positive leads 24a and 24b are bonded to the first and second inner terminal portions 34 and 36, respectively, and are housed in the battery, thus reducing unnecessary stress.

As shown in FIG. 2, the ends of the first positive leads 24a extending from the single-plate cells 21 included in the first electrode assembly block 20a of the stacked electrode assembly 20 are stacked on top of each other and are bonded to the surface of the first inner terminal portion 34 of the positive terminal 30p facing the stacked electrode assembly by a process such as ultrasonic welding. On the other hand, the ends of the second positive leads 24b extending from the single-plate cells 21 included in the second electrode assembly block 20b of the stacked electrode assembly 20 are stacked on top of each other and are bonded to the surface of the second inner terminal portion 36 of the positive terminal 30p facing the stacked electrode assembly by a process such as ultrasonic welding.

When bonded in this way, the first positive leads 24a extending from the first electrode assembly block 20a of the stacked electrode assembly 20 have a substantially U-shape protruding toward one side in the thickness direction Z (upward in FIG. 2(a)), whereas the second positive leads 24b extending from the second electrode assembly block 20b of the stacked electrode assembly 20 have a substantially U-shape protruding toward the other side in the thickness direction Z (downward in FIG. 2(a)).

Although FIG. 2(a) shows a gap between the base ends of the positive leads 24a and 24b on the first electrode assembly block 20a side and the leading ends thereof connected to the positive terminal 30p, they can in practice be brought into contact with each other substantially without a gap therebetween. The first and second positive leads 24a and 24b may also be bonded to the positive terminal 30p so as to have a substantially U-shape protruding in the reverse direction. Furthermore, the first positive leads 24a or the second positive leads 24b, or both, may be bonded to the surfaces of the first and second inner terminal portions 34 and 36 facing away from the stacked electrode assembly 20.

As shown in FIG. 2(a), the outer terminal portion 32 of the positive terminal 30p extends from inside the casing 12 via the seal portions 16 to outside the battery. A fusible tape 17 is attached in advance to each side of the portion of the outer terminal portion 32 extending between the seal portions 16. Thus, when the seal portions 16 of the two casing members 12a and 12b are heat-sealed with the outer terminal portion 32 of the positive terminal 30p therebetween, the fusible tape 17 bonds to the inner surfaces of the seal portions 16, thus leaving no gap between the seal portions 16 in the area where the positive terminal 30p is disposed. This reliably prevents leakage of liquid from the seal portions 16 in the area where the positive terminal 30p is disposed.

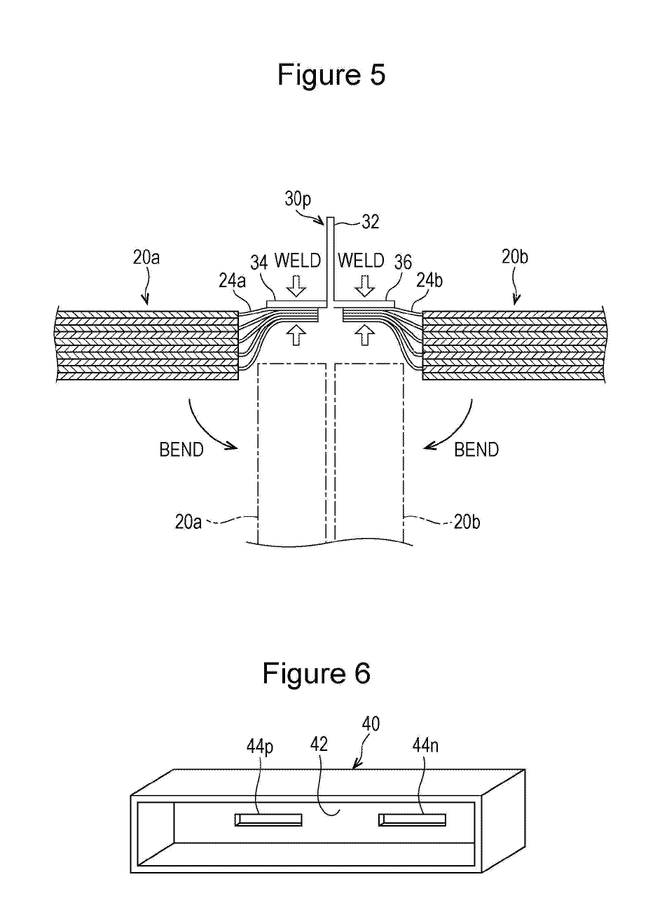

FIG. 5 illustrates how the positive leads 24a and 24b of the stacked electrode assembly 20 are bonded to the positive terminal 30p. As shown in FIG. 5, the first electrode assembly block 20a is placed parallel to the first inner terminal portion 34 of the positive terminal 30p, whereas the second electrode assembly block 20b is placed parallel to the second inner terminal portion 36 of the positive terminal 30p. In this state, the plurality of first positive leads 24a extending from the first electrode assembly block 20a are stacked on top of each other on the first inner terminal portion 34 and are welded together, whereas the plurality of second positive leads 24b extending from the second electrode assembly block 20b are stacked on top of each other on the second inner terminal portion 36 and are welded together. Similarly, the negative leads 26a and 26b extending from the first and second electrode assembly blocks 20a and 20b are bonded to the negative terminal 30n by welding. The electrode assembly blocks 20a and 20b are then bent at about 90° in the directions in which the electrode assembly blocks 20a and 20b approach each other. As a result, the stacked electrode assembly 20 in which the positive leads 24a and 24b and the negative leads 26a and 26b are bonded to the positive terminal 30p and the negative terminal 30n, respectively, is obtained.

Referring again to FIG. 2(a), a cover member 40 is disposed around the connections between the leads 24 and 26 of the stacked electrode assembly 20 and the terminals 30. The cover member 40 is preferably formed of, for example, a resin molding. As shown in FIG. 6, the cover member 40 has the shape of a rectangular prism with a rectangular opening on the side facing the stacked electrode assembly 20. On the other hand, the cover member 40 has two slots 44p and 44n formed in a sidewall 42 facing the opening. The slot 44p is a through-hole through which the outer terminal portion 32 of the positive terminal 30p is inserted, whereas the slot 44n is a through-hole through which the outer terminal portion 32 of the negative terminal 30n is inserted. Covering the connections between the leads 24 and 26 and the terminals 30 with the cover member 40 in this way effectively prevents these connections from being broken or otherwise damaged by external stress when the casing 12 is heat-sealed on the periphery thereof to form the seal portions 16.

FIG. 2(b) is a sectional view, corresponding to FIG. 2(a), of a stack-type battery 11 using conventionally known flat terminals as positive and negative terminals. This stack-type battery 11 includes a flat positive terminal 31p (and negative terminal 31n). As with an outer terminal portion 32, an inner terminal portion 38 located inside a casing 12 is flat. A plurality of first positive leads 24a extending from a first electrode assembly block 20a are stretched out in a substantially straight line or in a gently curved line and are bonded to the front surface of the inner terminal portion 38 by a process such as ultrasonic welding. A plurality of second positive leads 24b extending from a second electrode assembly block 20b are also stretched out in a substantially straight line or in a gently curved line and are bonded to the back surface of the inner terminal portion 38 by a process such as ultrasonic welding.

Since the stack-type battery 11 shown in FIG. 2(b) has a configuration in which a stacked electrode assembly 20 composed of a large number of stacked single-plate cells 21 is housed in the casing 12 composed of the cup-shaped casing members 12a and 12b bonded together, the positions from which the positive terminal 31p and the negative terminal extend are limited to the area around the center of the battery in the thickness direction Z parallel to the stacking direction of the single-plate cells. Thus, connecting a large number of leads 24 and 26 to the front and back surfaces of the flat positive terminal 31p and the negative terminal 31n in the battery results in an increased battery interior volume loss near the connections in the area around the center. As a result, the distance L2 from the stacked electrode assembly 20 to the sidewall surface of the casing 12 becomes longer, and the length of the cover member 40A in the length direction needs to be correspondingly larger.

In contrast, since the stack-type battery 10 according to this embodiment uses the terminals 30 having a T-shaped side profile formed by the first and second inner terminal portions 34 and 36 and the outer terminal portion 32, the first and second positive leads 24a and 24b and the first and second positive leads 26a and 26b can be bonded to the positive terminal 30p and the negative terminal 30n, respectively, while being bent into a substantially U-shape. This reduces the waste of the battery interior space around the connections between the leads and the inner terminal portions. Thus, the length L1 between the end surface of the stacked electrode assembly 20 from which the leads 24 and 26 extend and the sidewall surface of the casing 12 can be made relatively small, which contributes to a reduction in the size and an increase in the energy density of the stack-type battery 10.

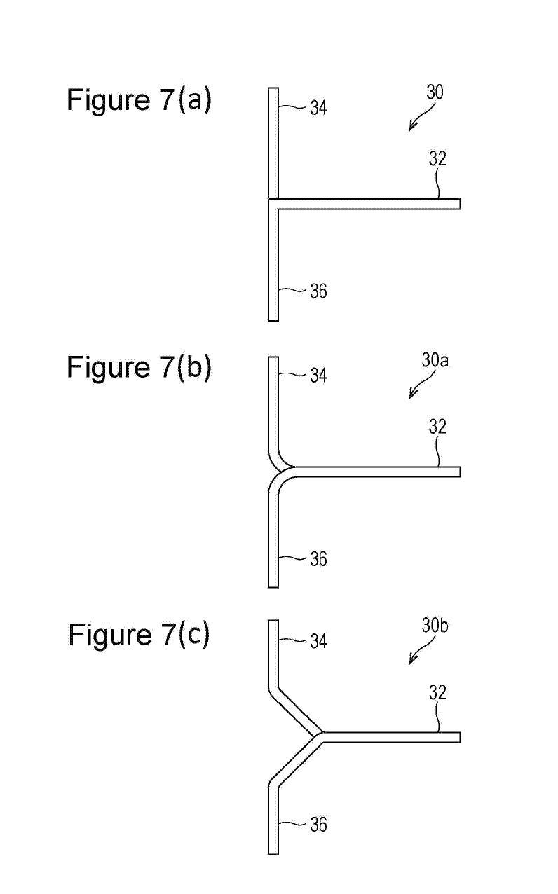

FIG. 7(a) is a side view of the terminals 30 according to this embodiment, and FIGS. 7(b) and 7(c) are side views of terminals according to modifications. As shown in FIG. 7(a), the case where the terminals 30 have a T-shaped side profile famed by bending the base ends of the first and second inner terminal portions 34 and 36 perpendicular to the outer terminal portion 32 has been described in this embodiment; however, this should not be construed as limiting. For example, like a terminal 30a shown in FIG. 7(b), the terminals 30 may have a T-shaped side profile formed by bending the base ends of the first and second inner terminal portions 34 and 36 into an arc shape with a predetermined radius of curvature. Alternatively, like a terminal 30b shown in FIG. 7(c), the terminals 30 may have a T-shaped side profile formed by bending the base ends of the first and second inner terminal portions 34 and 36 while foaming inclined portions with a predetermined angle of inclination.

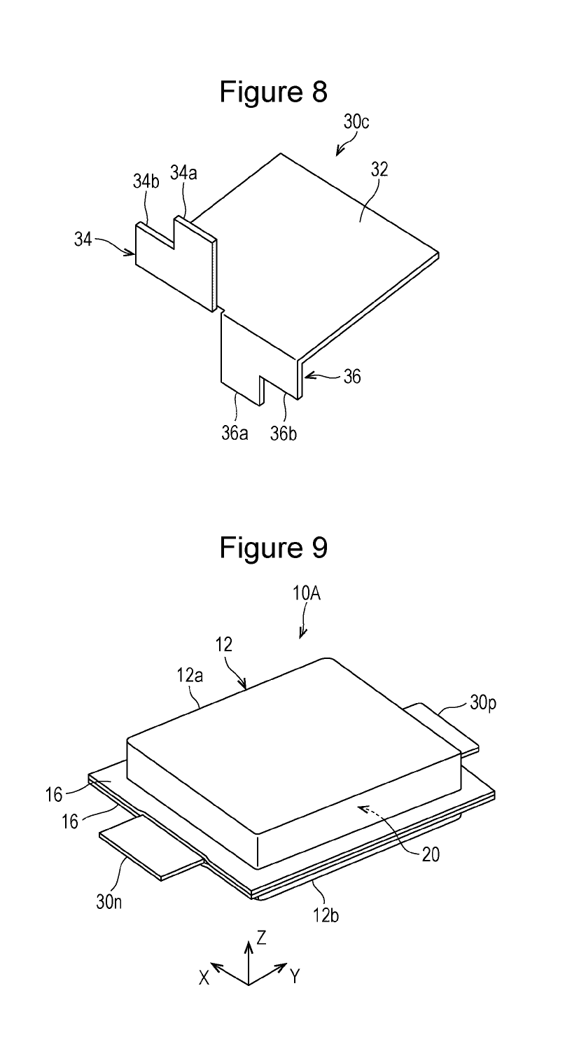

FIG. 8 is a perspective view of a terminal 30c according to a further modification. Whereas this terminal 30c and the terminals 30 according to this embodiment have the common feature of having a T-shaped side profile, they differ in that the length, from the bent point, of the inner terminal portions to which the leads are connected changes in multiple steps. Specifically, the first inner terminal portion 34 to which the first positive leads 24a are connected includes a portion 34a having a longer length from the bent portion and a portion 34b having a shorter length from the bent portion, whereas the second inner terminal portion 36 to which the second positive leads 24b are connected includes a portion 36a having a longer length from the bent portion and a portion 36b having a shorter length from the bent portion. Varying the length of the inner terminal portions in this way so that the positions where the leads are connected are dispersed reduces the number of leads connected at one position, which results in more reliable welding connections, and also contributes to, for example, reduced variation in connection resistance.

The present invention is not limited to the foregoing embodiment and its modifications; rather, various improvements and modifications can be made within the scope of the claims of the present application and their equivalents.

For example, although the stack-type battery 10 in which the positive terminal 30p and the negative terminal 30n extend in the same direction in the length direction Y has been described above, this should not be construed as limiting. As shown in FIG. 9, a stack-type battery 10A is also possible in which the positive terminal 30p and the negative terminal 30n extend from the casing 12 in opposite directions. In this case, the positive and negative leads are also famed so as to extend from both ends of the stacked electrode assembly in the length direction. In this case, it is possible that only one of the positive terminal 30p and the negative terminal 30n is a terminal having a T-shaped side profile, with the other being a flat terminal as shown in FIG. 2(b). This reduces the volume loss at an end on one side of the stack-type battery 10A in the length direction, thus contributing to a reduction in size.

### INDUSTRIAL APPLICABILITY

The present invention is applicable to stack-type batteries.

### REFERENCE SIGNS LIST

10, 10A stack-type battery
12 casing
12a, 12b casing member
14 housing space
15 body
16 seal portion
17 fusible tape
20 stacked electrode assembly
20a first electrode assembly block
20b second electrode assembly block
21 single-plate cell
22 positive electrode
23 negative electrode
24, 26 lead
24a first positive lead
24b second positive lead
26a, 26b negative lead
30, 30a, 30b, 30c terminal
30p positive terminal
30n negative terminal
32 outer terminal portion
34 first inner terminal portion
36 second inner terminal portion
40, 40A cover member
42 sidewall
44p, 44n slot

1. A stack-type battery comprising:
a casing;
a stacked electrode assembly housed in the casing and comprising a plurality of stacked single-plate cells, each comprising positive and negative electrodes stacked with a separator therebetween;
a positive terminal to which positive leads extending from the positive electrodes of the single-plate cells forming the stacked electrode assembly are connected; and
a negative terminal to which negative leads extending from the negative electrodes of the single-plate cells forming the stacked electrode assembly are connected,
wherein the stacked electrode assembly is divided into first and second electrode assembly blocks in a stacking direction, and
wherein at least one of the positive and negative terminals comprises a first inner terminal portion to which the leads of the first electrode assembly block are connected, a second inner terminal portion to which the leads of the second electrode assembly block are connected, and an outer terminal portion continuous with base ends of the first and second inner terminal portions and extending outside the casing, the at least one of the positive and negative terminals having a T-shaped side profile formed by the first and second inner terminal portions and the outer terminal portion.

2. The stack-type battery according to claim 1, wherein the first and second inner terminal portions of the at least one of the positive and negative terminals having the T-shaped side profile are formed by bending portions on both sides of a cut made in a metal plate at substantially 90° in opposite directions.

3. The stack-type battery according to claim 1, wherein a cover member is provided so as to cover a region where the leads extending from the stacked electrode assembly are connected to the at least one of the positive and negative terminals having the T-shaped side profile, the cover member having formed therein a through-hole through which the outer terminal portion is inserted.
